(19) United States
(12) Patent Application Publication
(10) Pub. No.: US 2006/0070281 A1
(43) Pub. Date: Apr. 6, 2006

(54) Illuminated advertising trash receptacle

(76) Inventor: Caesar A. Passannante, Katonah, NY (US)

Correspondence Address: BROWN, RAYSMAN, MILLSTEIN, FELDER & STEINER LLP, 900 THIRD AVENUE, NEW YORK, NY, 10022, US

(21) Appl. No.: 10/310,974

(22) Filed: Dec. 6, 2002

Related U.S. Application Data
(60) Provisional application No. 60/336,141, filed on Dec. 6, 2001.

(51) Int. Cl. G09F 23/00

(52) U.S. Cl. 40/567

(57) ABSTRACT

An illuminated advertising trash receptacle including stationary base having a power source, an illuminated carousel having transparent viewing areas and an interior space sized to receive a liner container, at least one lighting device to illuminate the advertisements, a turntable that supports the illuminated carousel on the stationary base and allows rotation of the illuminated carousel relative to the stationary base, and a drive mechanism for rotating the illuminated carousel relative to the stationary base. In another embodiment, an illuminated advertising trash receptacle includes a storage device adapted to store a plurality of electronic advertisements, a display screen adapted to display at least one of the plurality of electronic advertisements, and a controller adapted to change which of the electronic advertisements is displayed on the display screen.

### RELATED APPLICATIONS

This application claims priority from provisional patent application Ser. No. 60/336,141, filed on Dec. 6, 2001, incorporated herein by reference.

### BACKGROUND OF THE INVENTION

1. Field of the Invention

The present invention is directed to receptacles having illuminated advertising. In particular, the present invention is directed to such illuminated advertising trash receptacles that allow viewing of more than one advertisement.

2. Description of Related Art

Trash receptacles having advertising panels have been known in the art. Additionally, with the advent of low energy light sources, illumination of such advertising panels has also become known in the art. Until now, light bulbs have been used to illuminate the panels. For example, U.S. Pat. No. 757,403 to Leveen shows a trash paper box having sides formed from transparent slides with advertising matter painted thereon. Electrical illuminating devices, such as incandescent bulbs, are provided in a space behind the slides and an inner box (in which the trash is collected). With the popularity of solar power, it has become known to power the light bulbs of illuminated trash receptacles with solar cells and electrical storage batteries, as described in U.S. Pat. No. 4,827,643 to Stamps, Jr.

The lighting devices used to illuminate conventional trash receptacles cannot uniformly illuminate an advertising panel because known light bulbs are of a set size and shape that does not closely correspond to the size and shape of standard advertising panels. The size of the light bulb behind the advertising panel is generally smaller than the surface area of the advertising panel. Thus, the portion of the advertising panel behind which the light bulb is positioned is generally more brightly illuminated than the other portions of the panel.

Moreover, because of the typical shape of currently available light bulbs, a compartment that is several times the thickness of the advertising panel itself must be provided to accommodate the desired lighting device that illuminates the advertising panel. Because the light bulbs that have been used in prior art illuminated trash receptacles also generate a significant amount of heat which may damage the advertising panel, sufficient space must be provided not only to accommodate the light bulb itself, but also to provide sufficient spacing between the light bulb and the advertising panel to protect the panel from damage from the bulb.

Another drawback of the use of common lighting devices used in the prior art is that the devices burn out and must be regularly replaced. Generally, incandescent light bulbs are screwed into a socket. Thus, sufficient access to the interior space in which the lighting mechanism is housed must be provided to unscrew the burnt out bulb and replace it with a new one. A related drawback is the sensitivity of the lighting devices that have been used in prior art illuminated trash receptacles. In particular, incandescent bulbs have filaments that not only wear out but also break if subjected to sufficient impact or vibrations.

Fluorescent light bulbs provide advantages over conventional incandescent light bulbs in that they last longer than incandescent bulbs. Of course, fluorescent bulbs also require sufficient access space for replacement so that proper alignment of the bulb and the connection socket may be achieved without also covering the bulb.

To address some of the limitations of the conventional illuminated trash receptacles, U.S. Pat. No. 5,947,584 issued to Passanante et al. discloses an illuminated trash receptacle having a long-lasting lighting mechanism for illuminating the advertising panels in the trash receptacle. In particular, the reference discloses the use of a flat light device with a light-emitting surface that provides uniform illumination of an advertisement. The flat light device may be a flat panel lamp such as an electroluminescent lamp, or a light guide that provides even distribution of a light source.

U.S. Pat. No. 6,148,552 issued to Dumontier et al. discloses a receptacle that allows viewing of more than one advertisement. In particular, Dumontier et al. discloses a device for rotatably displaying advertising material on a trash receptacle. The trash receptacle includes stationary transparent outer shell (3), and a rotating transparent inner shell (5). The inner shell (5) is driven by a driving wheel (87) mounted on a drive shaft of a motor. However, backlighting of the advertisement using conventional fluorescent tubes positioned behind the advertisement as disclosed in Dumontier et al. requires a significant amount of space which otherwise, can be used to increase capacity of the receptacle or make the receptacle more compact. In addition, the lighting implementation as disclosed in Dumontier et al. requires significant amount of power to operate and even more power at start up due to the start up power requirements of the fluorescent lamps (135) used. Furthermore, the lighting implementation as disclosed in Dumontier et al. results in significant disparity in lighting brightness among various regions of the displayed advertisement, the portion of the advertisement most proximate to the fluorescent lamps being the brightest.

### SUMMARY OF THE INVENTION

In view of the foregoing, there still exists an unfulfilled need for an illuminated advertising trash receptacle that enhances effectiveness of advertising. In addition, there also exists an unfulfilled need for such an illuminated advertising trash receptacle that minimizes power consumption, especially at start up. Moreover, there exists an unfulfilled need for such an illuminated advertising trash receptacle that illuminates the advertisement evenly. Furthermore, there exists an unfulfilled need for a method that encourages use of such trash receptacles.

Accordingly, one advantage of the present invention is in providing an illuminated advertising trash receptacle that allows viewing of more than one advertisement.

Another advantage of the present invention is in providing an efficient mechanism for allowing viewing of more than one advertisement while minimizing power consumption.

Still another advantage of the present invention is in providing an illuminated advertising trash receptacle with an efficient power management to minimize power consumption and requirements, especially at start up.

Yet another advantage of the present invention is in providing an illuminated advertising trash receptacle that illuminates the advertisement evenly.

Moreover, in accordance with another embodiment, another aspect of the present invention is in providing a method of advertising which encourages use of such illuminated advertising trash receptacles.

Still another advantage of the present invention is in providing additional utility for such illuminated advertising trash receptacles by using such trash receptacles to establish a local wireless network.

The above advantages and others are attained by providing an illuminated advertising trash receptacle in accordance with one embodiment including stationary base, a power source, an illuminated carousel having at least one substantially transparent viewing area sized to housing advertisements therein, and an interior space sized to receive a liner container therein, at least one lighting device to evenly illuminate the advertisements, the lighting device having dimensions substantially the same as the viewing area, a turntable positioned to support the illuminated carousel on the stationary base, and adapted to allow rotation of the illuminated carousel relative to the stationary base, and a drive mechanism for rotating the illuminated carousel relative to the stationary base.

In accordance with one embodiment, the turntable supports the illuminated carousel includes a race with a friction reducing bearing that facilitates rotation of the carousel by the drive mechanism. In another embodiment, the drive mechanism includes an electric motor which may be mounted to rotate with the illuminated carousel. The turntable may include a track rail that provides power from the power source to the electric motor and the rest of the electronics as the carousel rotates relative to the stationary base.

In accordance with still another embodiment of the present invention, the illuminated advertising trash receptacle further includes a load circuit that monitors load on the electric motor. The load circuit terminates power to the electric motor when the monitored load exceeds a predetermined load. In another embodiment, the illuminated advertising trash receptacle has a plurality of lighting devices and a sequencer that provides power from the power source to each of the plurality of lighting devices sequentially so that one lighting device is turned on at a time. In addition, the sequencer further supplies power to the drive mechanism after sequentially providing power to each of the plurality of lighting devices.

In accordance with one embodiment, the power source of the illuminated advertising trash receptacle is a portable, rechargeable power source such as a plurality of rechargeable batteries. In another embodiment, the power source is a fuel cell. In this regard, the fuel cell may include a fuel container including nickel metal hydride or borax therein.

In one embodiment, the lighting device of the illuminated advertising trash receptacle includes a light guide which may be made of an acrylic sheet. In accordance with another embodiment, the lighting device is an electroluminescent lamp.

In accordance with yet another embodiment, the illuminated advertising trash receptacle further includes a components bay that houses an antenna, transmitter and receiver to allow the illuminated advertising trash receptacle to function as an access point for a local wireless network.

In accordance with another embodiment of the present invention, the above noted advantages and others are attained by an illuminated advertising trash receptacle including at least one side wall, a power source, a storage device adapted to store a plurality of electronic advertisements, a display screen attached to an outer surface of the at least one side wall, the display device being adapted to display at least one of the plurality of electronic advertisements, and a controller adapted to change which of the plurality of electronic advertisements is displayed on the display screen.

In one embodiment, the controller is adapted to change which electronic advertisement is displayed on the display screen based at least on duration of time each of the electronic advertisements are displayed. The display screen may be implemented as an LCD, LED or plasma screens. In one embodiment, the display screen may be touch sensitive to allow viewer interaction with displayed electronic advertisement.

In accordance with another embodiment of the illuminated advertising trash receptacle, a receiver is provided which is adapted to receive transmissions of the electronic advertisements. A transmitter may be provided in another embodiment to transmit information status of the illuminated advertising trash receptacle and electronic advertisements being displayed.

In still another embodiment, the illuminated advertising trash receptacle includes a speaker to provide audio information to viewers of the electronic advertisements. In yet another embodiment, the illuminated advertising trash receptacle is provided with a sensor adapted to detect presence of an individual viewing the electronic advertisements displayed, and a counter for counting number of individuals that viewed the electronic advertisements.

In yet another embodiment, the illuminated advertising trash receptacle further includes a components bay that houses an antenna, transmitter and receiver to allow the illuminated advertising trash receptacle to function as an access point for a local wireless network.

In accordance with still another aspect of the present invention, a method of advertising is provided, the method including the steps of providing at least one advertisement trash receptacle at a property location, the advertisement trash receptacle having an interior space to receive trash therein, advertising products and/or services of a sponsor in the advertisement trash receptacle, collecting a fee from the sponsor for the advertisement in the advertisement trash receptacle, and paying at least a portion of the collected fee from the sponsor to owner of the property location. In accordance with another embodiment, the present method may further include the steps of regularly servicing the advertisement trash receptacle, where the servicing is performed without cost to the owner of the property location.

In accordance with another embodiment, the method further includes the step of providing a plurality of advertisement trash receptacles, the advertisement trash receptacles including a components bay housing an antenna, transmitter and receiver which allow the plurality of advertisement trash receptacles to function as access points for a local wireless network. Furthermore, the method may further include the step of charging a fee for accessing the local wireless network.

In accordance with still another embodiment, an illuminated advertising trash receptacle is provided including a stationary base, a power source, a plurality of viewing areas that allow viewing of plurality of advertisements, a plurality of lighting devices to evenly illuminate the advertisements, the lighting devices being dimensioned to correspond to the viewing area, and a sequencer that provides power from the power source to each of the plurality of lighting devices sequentially so that one lighting device is turned on at a time.

In yet another embodiment, an illuminated advertising trash receptacle is provided including a stationary base, at least one viewing area that allows viewing of the advertisement, at least one lighting device to evenly illuminate the advertisement, the lighting device having dimensions substantially same as the viewing area, and a portable, rechargeable power source for providing power to the at least one lighting device. In this regard, the power source may be a fuel cell, for example, having a fuel container including at least one of nickel metal hydride and borax therein.

In accordance with still another embodiment, an illuminated advertising trash receptacle is provided including stationary base, a power source, at least one viewing area that allows viewing of the advertisement, at least one lighting device to evenly illuminate the advertisement, the lighting device having dimensions substantially same as the viewing area, and a components bay that houses an antenna, transmitter and receiver to allow the illuminated advertising trash receptacle to function as an access point for a local wireless network.

In accordance with yet another embodiment, an illuminated advertising trash receptacle is provided including stationary base, a power source, at least one viewing area that allows viewing of the advertisement, at least one lighting device to evenly illuminate the advertisement, the lighting device having dimensions substantially same as the viewing area, and a speaker to provide audio information to viewers of the advertisement.

In another embodiment, an illuminated advertising trash receptacle is provided including stationary base, a power source, at least one viewing area that allows viewing of the advertisement, at least one lighting device to evenly illuminate the advertisement, the lighting device having dimensions substantially same as the viewing area, and a sensor adapted to detect presence of an individual viewing the advertisement. In this regard, a counter may also be provided for counting number of individuals that viewed the advertisement.

These and other advantages and features of the present invention will become more apparent from the following detailed description of the preferred embodiments of the present invention when viewed in conjunction with the accompanying drawings.

### BRIEF DESCRIPTION OF THE DRAWINGS

FIG. 1 is a perspective view of an illuminated advertising trash receptacle in accordance with one embodiment of the present invention.

FIG. 2 is a front view of the illuminated advertising trash receptacle of FIG. 1.

FIG. 3 is a cross-sectional view of the illuminated advertising trash receptacle of FIG. 1 viewed along arrows “A-A”.

FIG. 4 is a cross-sectional view of the illuminated advertising trash receptacle of FIG. 2 viewed along arrows “B-B” as shown in FIG. 3.

FIG. 5 is a perspective view of a stationary base where the power source is implemented as a fuel cell.

FIG. 6 is a cross-sectional view of the liner container and the blast resistant liner in accordance with one embodiment of the present invention.

FIG. 7 is a partial assembly view of the vertical supports mounted to the turntable of the illuminated advertising trash receptacle.

FIG. 8 is a partial assembly view of one vertical support in accordance with one embodiment.

FIG. 9 is a partial assembly view of another vertical support in accordance with another embodiment.

FIG. 10 is a top view of a lighting device in accordance with one embodiment.

FIG. 11 is a perspective view of an electric motor in accordance with one embodiment.

FIG. 12 is an enlarged view of a turntable in accordance with one embodiment.

FIG. 13 is a partially assembled view of the first frame member in accordance with one embodiment.

FIG. 14 is a front view of an illuminated advertising trash receptacle in accordance with another embodiment of the present invention.

FIG. 15 is a schematic view of the stationary base of the illuminated advertising trash receptacle of FIG. 14.

FIG. 16 is a perspective view of an illuminated advertising trash receptacle installed in tower docking unit in accordance with another embodiment of the present invention.

FIG. 17 is a schematic illustration of a plurality of tower docking stations used to establish a local wireless network.

FIG. 18 is a schematic illustration detailing the components of the local wireless network in accordance with one embodiment.

### DETAILED DESCRIPTION OF THE PREFERRED EMBODIMENT

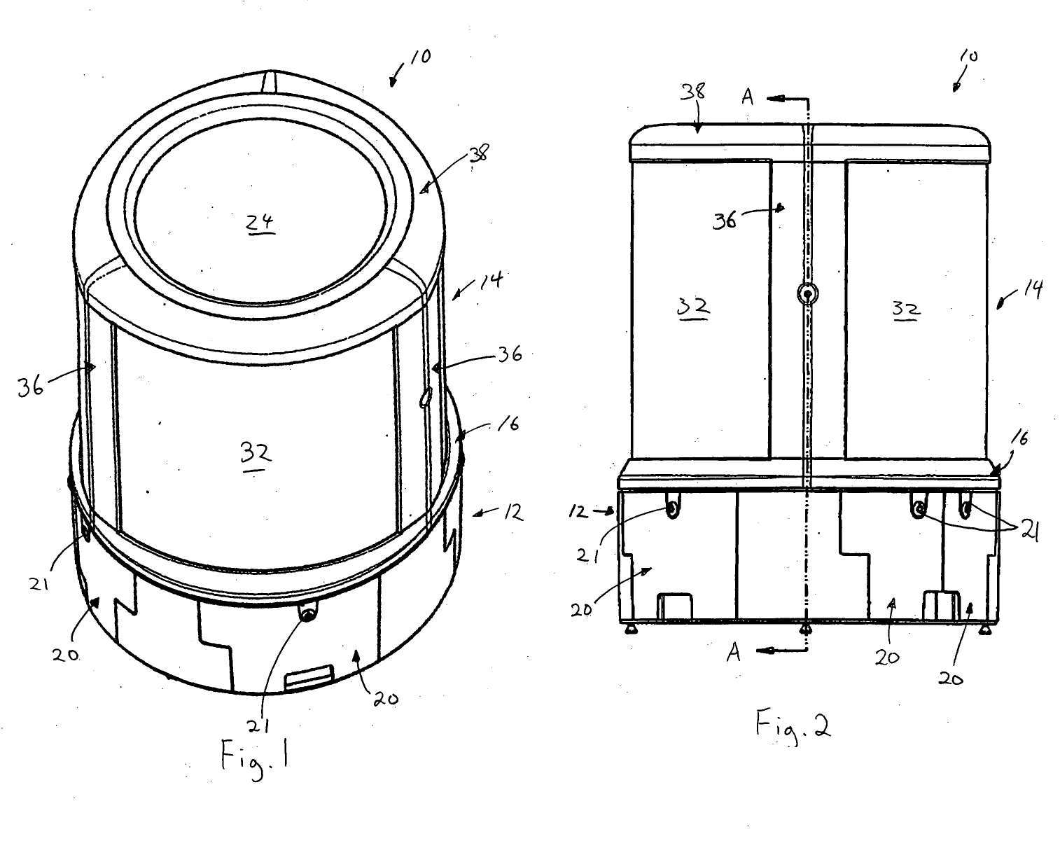

FIGS. 1 and 2 show views of an illuminated advertising trash receptacle 10 in accordance with one embodiment of the present invention. As described in further detail below, the illuminated advertising trash receptacle 10 enhances effectiveness of advertising by allowing viewing of more than one advertisement. In this regard, the illuminated advertising trash receptacle 10 provides an efficient mechanism for displaying more than one advertisement while minimizing power consumption, especially at start up. Moreover, the illuminated advertising trash receptacle 10 illuminates the advertisement in an even manner to enhance the advertisement's effectiveness.

The illuminated advertising trash receptacle 10 in accordance with the illustrated embodiment of FIGS. 1 and 2 includes a stationary base 12, and an illuminated carousel 14 that forms the outside of the trash receptacle 10 and rotates relative to the stationary base 12. The illuminated carousel 14 is supported by a turntable 16 that is positioned between the stationary base 12 and the illuminated carousel 14. As described in further detail below relative to FIGS. 7 and 8, the turntable 16 allows the illuminated carousel 14 to be rotated relative to the stationary base 12.

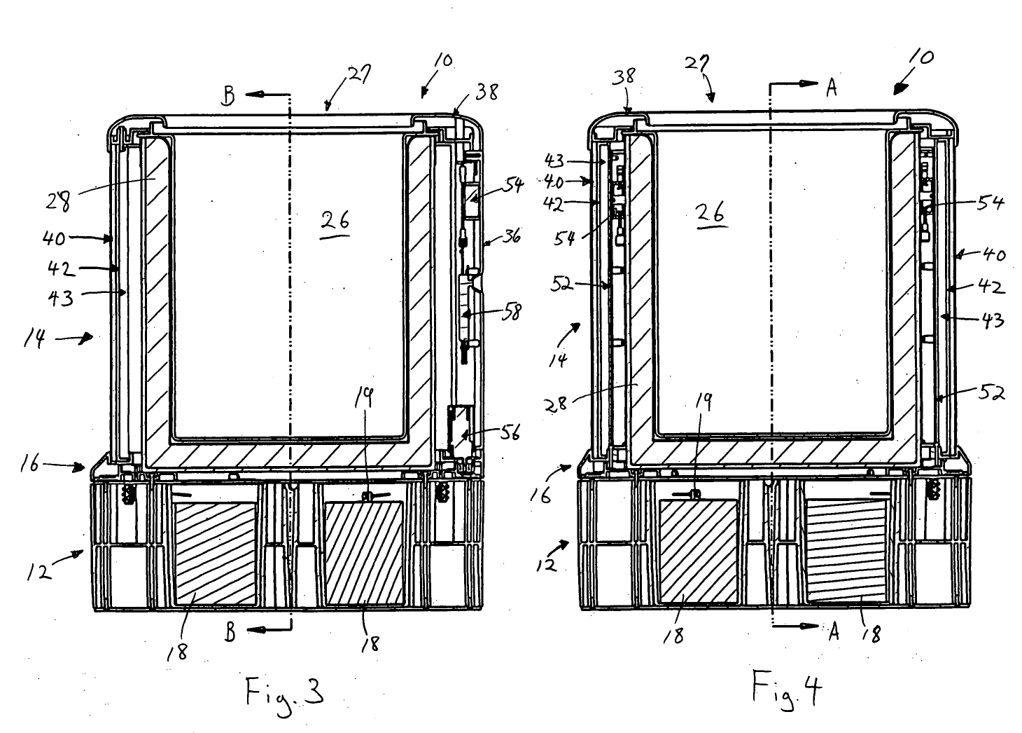

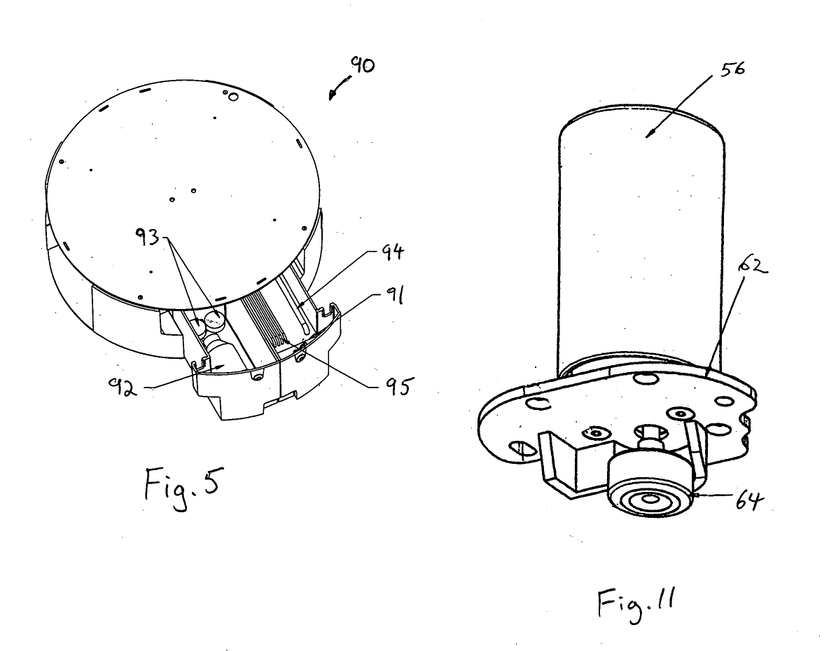

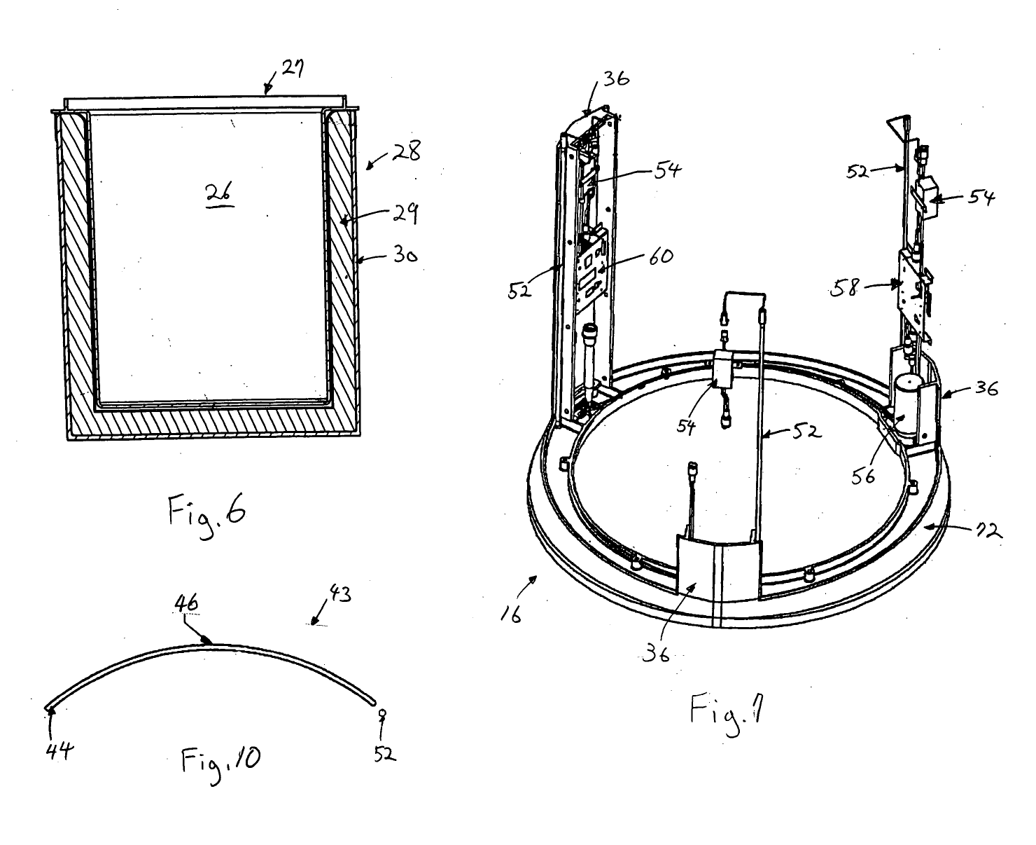

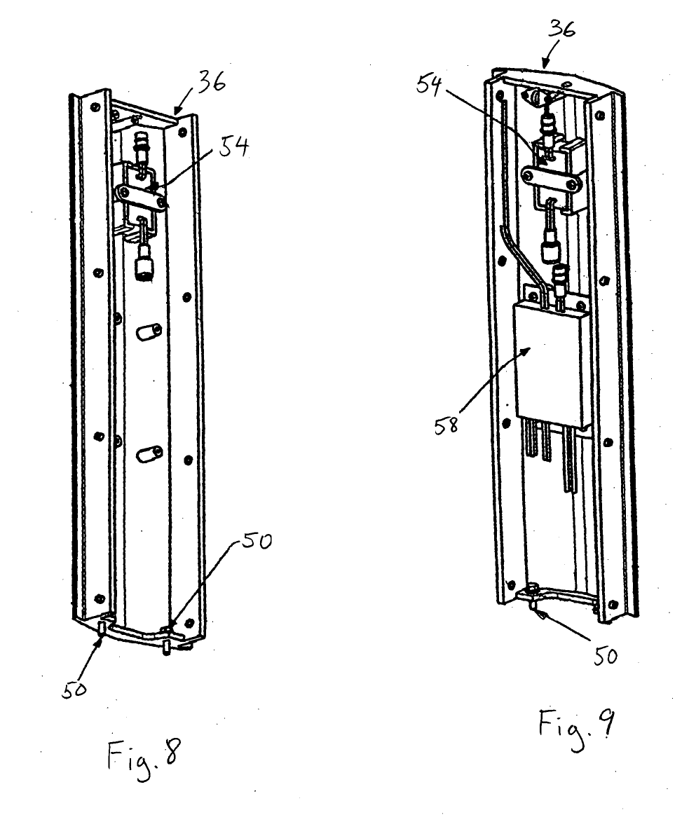

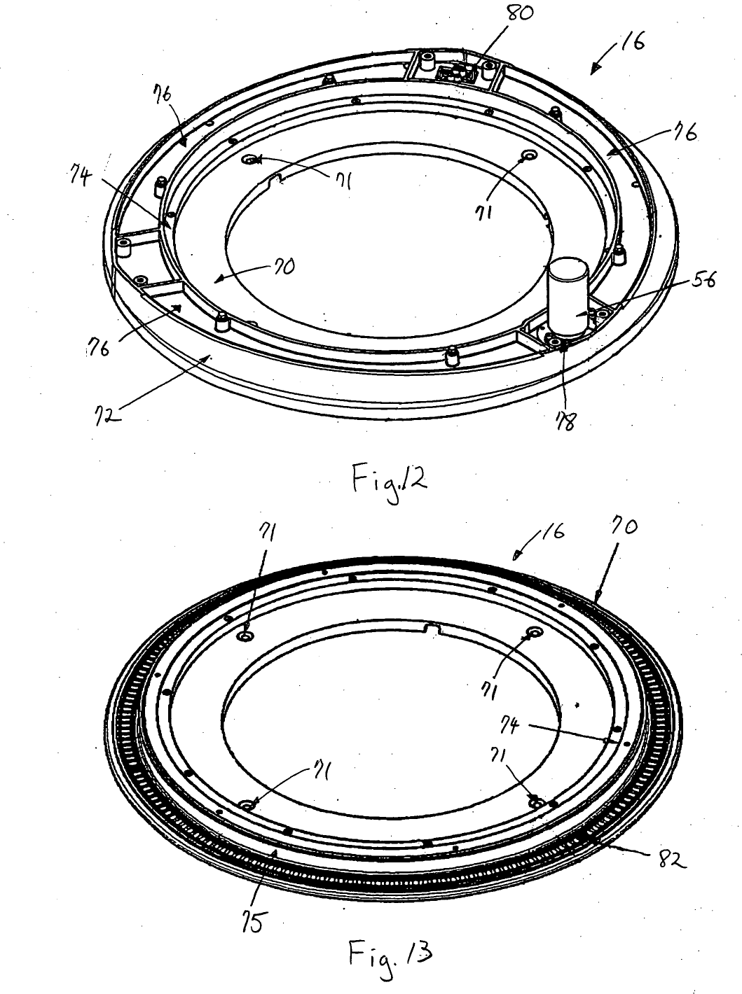

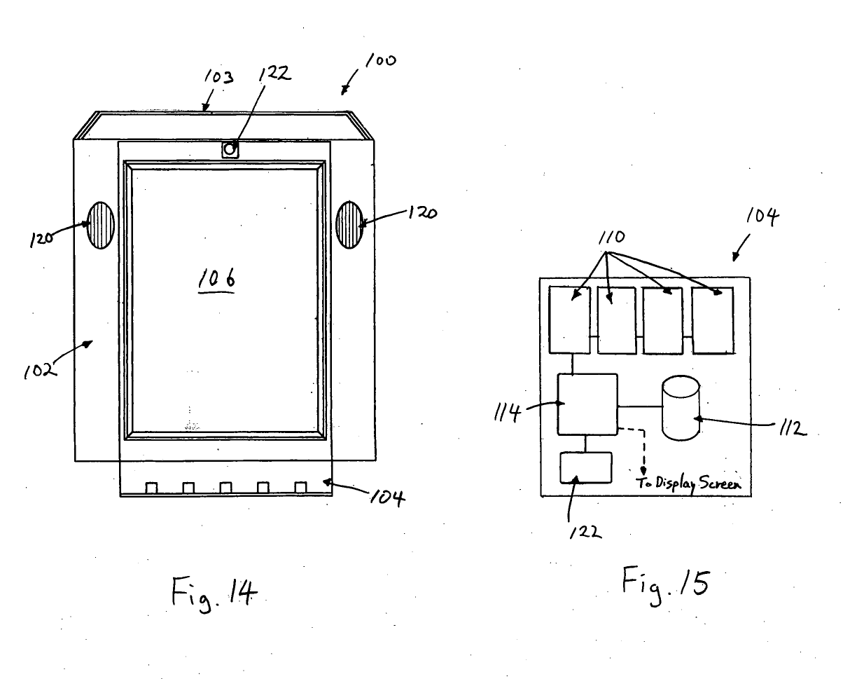

The stationary base 12 houses a power source, which in the present embodiment, includes a plurality of rechargeable batteries 18 shown in the cross-sectional views of FIGS. 3 and 4. The rechargeable batteries 18 may be of any appropriate power rating sufficient to ensure proper operation of the illuminated advertising trash receptacle 10. In the present illustrated embodiment, the rechargeable batteries 18 may be automotive or marine type batteries that are electrically connected together via terminals 19. The rechargeable batteries 18 are housed in one or more compartments 20 of the stationary base 12, the compartments 20 being lockable in the present embodiment via locks 21 shown in FIGS. 1 and 2 to prevent unauthorized tampering with the power source.

It should be noted that whereas in the above embodiment, the power source is a plurality of rechargeable batteries, in other embodiments, other types of power supplies may be used instead. For example, a single large battery may be used instead of a plurality of automotive type batteries. Alternatively, an outlet connection may be provided so that power source is supplied by the power grid of the local electrical utility.

FIG. 5 shows one implementation of the stationary base 90 in which a fuel cell 91 is used to provide power to the illuminated advertising trash receptacle in accordance with another embodiment of the present invention. As shown, the fuel cell 91 receives hydrogen fuel that is stored in the fuel container 92, the quantity of which is regulated by the regulator 93. The hydrogen fuel is provided to the fuel cell 91 via the fuel feed line 94, the fuel cell 91 using the hydrogen fuel to generate electricity. The electricity is distributed via the connections 95 to various components of the illuminated advertising trash receptacle to operate the trash receptacle in the manner further described in detail below. The use of the fuel cell 91 is very clean resulting in small amount of water as the byproduct. Such a fuel cell is available, for example, from H-POWER CORP. of New Jersey, U.S.A.

The fuel container 92 may include metal canisters having nickel metal hydride therein to increase storage capacity. In yet another alternative, the fuel container 92 may include borax for enhancing the hydrogen storage capacity of the fuel container 92. These embodiments that utilize the above described enhancements to the fuel container 92 are especially advantageous in implementing the illuminated advertising trash receptacle 10 because they greatly enhance the safety of storing hydrogen while increasing hydrogen storage capacity. Of course, these are only examples of power supplies that may be used and other power sources may be used instead.

Referring again to FIGS. 1 to 4, the illuminated carousel 14 of the illuminated advertising trash receptacle 10 is generally cylindrical in shape as shown and includes an interior space 24 that is sized to receive a liner container 26 therein as most clearly shown in FIGS. 3 and 4, the liner container 26 having an opening 27. The liner container 26 allows appropriate bag or liner to be used for collection of refuse or other objects via the opening 27. In the present embodiment, the liner container 26 does not rotate with the illuminated carousel 14 that surrounds the liner container 26, but remains stationary with the base 12 negating refuse weight issues.

In the present illustrated embodiment, the liner container 26 is further provided with an optional blast resistant liner 28 to resists radial outward explosion of the illuminated advertising trash receptacle 10 in the instance where an explosive device is detonated within the receptacle 10. The blast resistant liner 28 together with the liner container 26 is most clearly shown in FIG. 6. The blast resistant liner 28 includes blast absorption material 29 and a reinforcement outer shell 30 made of a very strong and ductile material such as steel. Thus, the energy from the explosion within the liner container is partially absorbed and resisted in the radial direction, and is also directed upward toward the opening 27 of the liner container 26, thereby reducing the risk of injury to bystanders in the proximity of the trash receptacle 10 at the time of the explosion. Of course, it should be noted that the blast resistant liner 28 is merely an optional feature and need not be provided to practice the present invention. In an implementation not having such a blast resistant liner, the liner container 26 can be appropriately sized so that it generally corresponds to the dimension of the outer shell 30 of the blast resistant liner 28.

Referring again to FIGS. 1 and 2, the illuminated carousel 14 is also provided with a plurality of substantially transparent viewing areas 32 that are sized to house advertisements therein. In this regard, the transparent viewing areas 32 are bounded by the vertical supports 36, a top cover 38, and the turntable 16. Of course, it should be understood that the transparent viewing areas 32 are curved in an arc due to the cylindrical shape of the illustrated embodiment. Moreover, three separate viewing areas are provided as shown. However, it should be evident that in other embodiments of the present invention, transparent viewing areas having different shapes and different numbers of viewing areas may be provided instead, depending on the shape and configuration of the illuminated advertising trash receptacle.

In the illustrated embodiment as shown in FIGS. 3 and 4, clear protective panels 40 are provided to protect advertisements 42 displayed in the viewing areas 32. In one embodiment, the clear protective panel 40 is formed from a tough, non-breakable, shatter-proof material such as a clear plastic material. The clear protective panel may also be water-proof, scratch and graffiti resistant. In this regard, the protective panel may be made of polycarbonate such as LEXAN® available through General Electric Polymer Shapes of General Electric Company of Hamden, Conn., U.S.A. A separate graffiti resistant material or coating such as MARGUARD® may be applied to the clear protective panel, and in this regard, LEXAN MR10 ® by aforementioned General Electric may be used.

The advertisement 42 of the illustrated embodiment is preferably implemented as a transparency where the graphics of the advertisement is provided on the surface of the transparency. In this regard, the advertisement may be formed as a transparency sold as DURATRANS® from Eastman Kodak Company of Rochester, N.Y., U.S.A. Of course, other materials may be used for the advertisement in other embodiments as well.

In addition, the present illustrated embodiment of the illuminated advertising trash receptacle 10 is provided with lighting devices 43 for each of the viewing areas 32. As shown in FIGS. 3 and 4, the advertisements 42 are positioned between the clear protective panels 40 and the lighting devices 43. In accordance with the present invention, the lighting device 43 provides uniform illumination of the advertisement 42 and has a light emitting surface that is substantially the same size and shape as the viewing area 32 as described in further detail below. This allows the advertisement 42 to be displayed with even illumination to enhance the effectiveness of the advertisement 42.

The vertical supports 36 in the illustrated embodiment retain the sides of the clear protective panels 40 and the lighting devices 43, support the top cover 38, and further house various electronic components of the illuminated advertising trash receptacle 10. The advertisement 42 displayed by the illuminated carousel 14 may be changed by removing the top cover 38 and replacing the advertisement 42 with another advertisement.

As shown in the partial assembly view of FIG. 7, each of the vertical supports 36 in the illustrated embodiment are adapted to be mounted to the turntable 16, for example, via mounting fasteners 50 as shown in FIGS. 8 and 9 that engage corresponding openings in the turntable 16. As shown most clearly in FIGS. 7 to 9, the vertical supports 36 of the illustrated embodiment house various electronic components that operate the drive mechanism to rotate the illuminated carousel 14 relative to the stationary base 12, as well as electronics for the lighting devices 43.

FIG. 10 illustrates a top view of one of the lighting devices 43 in accordance with one embodiment of the present invention. The lighting device 43 is substantially the same size and shape as the viewing area 32, and includes a light guide 44 and a fluorescent lamp 52. The light guide 44 has a light emitting surface 46 that uniformly distributes the light from the fluorescent lamp 52 to uniformly illuminate the advertisement 42. The light guide 44 may be made from acrylic sheets such as those disclosed in U.S. Pat. No. 5,947,584 to Passanante et al. on Sep. 7, 1999, the contents of which are incorporated herein by reference. The fluorescent lamps 52 may be obtained from any appropriate source such as LCD Lighting, Inc. of Stamford, Conn., U.S.A. This allows the advertisement 42 to be displayed with even illumination to enhance the effectiveness of the advertisement 42.

The fluorescent lamps 52 of the lighting devices 43 are housed by the vertical supports 36 in the illustrated embodiment. As shown in FIG. 4, the elongated fluorescent lamp 52 extends along the height of the clear protective panel 40. Moreover, referring again to the illustrated embodiment of FIGS. 7 to 9, the vertical supports 36 also house ballasts 54 for supplying power to the fluorescent lamps 52 of the lighting devices 43.

Of course, it should also be noted that the specific use and configuration of the elongated fluorescent lamps as illustrated and described above is merely provided as one example implementation and other lighting devices in different configurations may be used instead in other embodiments of the present invention. For example, fluorescent lamps and light guides of varying shapes may be used. In yet another alternative, electroluminescent lamps for the lighting device 43 may be used instead of fluorescent lamps and the light guide. In such an implementation, the electroluminescent lamps are dimensioned substantially same as the viewing area to evenly illuminate the advertisements and fluorescent lamps would not be required. Such electroluminescent lamps are sold by E-LUX of Camarillo, Calif., U.S.A.

In addition, one or more of the vertical supports 36 house various other electronic components that contribute to the functionality of the illuminated advertising trash receptacle 10. For example, in the illustrated embodiment as shown in FIG. 7, one of the vertical supports 36 houses an electric motor 56 that is a component of the drive mechanism that, together with the turntable 16, allows the rotation of the illuminated carousel 14 relative to the stationary base 12. As can be appreciated from examination of FIG. 7, the electric motor 56 is mounted to the portion of the turntable 16 so that the electric motor 56 rotates with the illuminated carousel 14 in the present implementation the details of the turntable being further described relative to FIGS. 12 and 13.

The vertical support 36 housing the electric motor 56 also houses a motor controller 58 having a load circuit that monitors the electrical load on the electrical motor 56. The motor controller 58 functions to terminate power to the electrical motor 56 to thereby stop the rotation of the illuminated carousel 14 when the monitored load exceeds a predetermined load. This stopping of rotation of the illuminated carousel 14 may be timed so that the rotation is resumed after a period of time, for example, after 30 seconds. Of course, this is merely an optional feature and such monitoring of the electric motor 56 need not be provided in other embodiments.

In addition, in accordance with the illustrated embodiment of FIG. 6, one of the other vertical supports 36 houses a light controller 60 that electronically controls the operation of each of the fluorescent lamps 52. This may be attained by electronically controlling the power provided to the corresponding ballasts 54 of the fluorescent lamps 52. The light controller 60 includes a sequencer circuit in the present embodiment that provides power from the power source to each of the plurality of fluorescent lamps 52 sequentially so that only one lighting device is turned on at a time. This is desirable to minimize simultaneous power draw from the power source during start up.

In particular, in the context where fluorescent lamps 52 are part of the lighting devices, such lamps typically require more power to be turned on than in the steady on state. Hence, even though the power source may be sufficient to provide sufficient power to operate the illuminated advertising trash receptacle 10 in steady state, if all of the fluorescent lamps 52 are turned on simultaneously, the power draw may significantly exceed the capacity of the power source so that the fluorescent lamps 52 cannot be turned on, for instance, during low power source conditions.

In addition, the sequencer of the light controller 60 may further be adapted to supply power to the electric motor 56 only after sequentially providing power to each of the plurality of fluorescent lamps 52 to ensure that there is sufficient power to turn the fluorescent lamps 52 on. As can be appreciated, this feature as provided by the light controller 60 is highly desirable if the power source for the illuminated advertising trash receptacle 10 is a rechargeable battery or other portable power storage device such as a fuel cell. Moreover, such feature is advantageous in colder climates where colder temperatures can diminish the power available from the power source.

Of course, it should be apparent that the vertical supports and the electronic components housed therein described above are merely provided as one example implementation. In this regard, it should be noted that the present invention is not limited to the specific implementations of the vertical supports shown and described but other embodiments of the present invention may be implemented differently.

The details of the electric motor 56 in accordance with one embodiment is shown in FIG. 11, the operation of which is described relative to FIGS. 11 to 13. The electric motor 56 is mounted to the turntable 16 via mounting bracket 62 and includes a drive wheel 64 that engages a drive surface 75 of the turntable 16 in the manner described below. A spring (not shown) may be provided that engages the mounting bracket 62 to thereby bias the drive wheel 64 against the race of the turntable 16.

FIG. 12 is an enlarged view of a turntable 16 in accordance with the embodiment of FIG. 7 but with the vertical supports removed. The turntable 16 includes a first frame member 70 that is secured to the stationary base 12 via securement holes 71. The first frame member 70 also supports the weight of the liner container 26 as most clearly shown in FIGS. 3 and 4. In this regard, it should be noted that the liner container 26 and the blast resistant liner 28 are not rotated with the illuminated carousel 14 in accordance with the illustrated embodiment.

The turntable 16 also includes a second frame member 72 that is adapted to rotate relative to the first frame member 70. In this regard, the turntable is provided with a friction reducing bearing 74 that interfaces with the first frame member 70 and the second frame member 72 of the turntable 16 to facilitate relative rotation between the two races. Thus, the bearing 74 facilitates the rotation of the second frame member 72 relative to the stationary base 12. As shown, the second frame member 72 of the present embodiment is designed to accommodate the vertical supports 36 as well as the clear protective panel 40 and the lighting device 43. In particular, the second frame member 72 is provided with channels 76 that are sized to receive the clear protective panel 40, the lighting device 43, and the advertisement 42 therein between. In addition, the second frame member 72 is provided with a motor mount 78 to allow mounting of the electric motor 56, which in the present embodiment, rotates with the illuminated carousel 14. The second frame member 72 is also provided with a harness connector 80 to allow proper connection of the light controller 60 as shown in FIG. 7.

FIG. 13 is a partially assembled view of the first frame member 70 in accordance with one embodiment of the present invention. The first frame member 70 includes a drive surface 75 that is engaged by the drive wheel 64 of the electric motor 56 shown in FIG. 11 to rotate the illuminated carousel 14 relative to the stationary base 12. In the illustrated embodiment, the engagement between the drive surface 75 and the drive wheel 64 is attained by friction. The drive wheel 64 may be made of rubber compound or other material so that frictional contact between the drive wheel 64 and the drive surface 75 is enhanced.

As described previously relative to FIG. 11, the electric motor 56 may be biased by a spring (not shown) so that the drive wheel 64 engages the drive surface 75 of the first frame member 70. In this regard, in accordance with another embodiment, instead of using a motor controller 58 having a load circuit that monitors the electrical load on the electrical motor 56, the spring may be selected accordingly so that the illuminated carousel 14 stops rotating when resistance is applied. In particular, the spring may be selected so that the electric motor 56 is biased to engage the drive surface 75 with sufficient force to ensure proper rotation of the illuminated carousel 14, but slippage occurs between the drive wheel 64 and the drive surface 75 when resistance is applied to the illuminated carousel 14, for example, when someone touches the illuminated carousel 14.

As previously noted, because the electric motor 56 is mounted to the rotating portion of the turntable 16, electric motor 56 itself rotates relative to the stationary base 12. In this regard, the first frame member 70 of the turntable 16 in accordance with the illustrated embodiment includes a track rail 82 that provides power from the power source, for example plurality of batteries 18 shown in FIGS. 3 and 4, to the electric motor 56 as it rotates with the illuminated carousel 14. Power from the power source is provided to the track rail 82 via connectors 80 in the illustrated embodiment where each of the rails of the track rail 82 are electrically connected so that they are opposite polarities. To provide electrical power to the electric motor 56 from the track rail 82, contact brushes (not shown) electrically connected to the electric motor 56 may be used, the contact brushes contacting the track rail 82 as the illuminated carousel 14 rotates.

Of course, it should be noted that the illustrated and described details of the turntable 16 and the electrical motor 56 discussed above relative to FIGS. 11 to 13 are merely provided as one example implementation, and other embodiments may be implemented differently. For example, the electrical motor 56 may be implemented so that it does not rotate with the illuminated carousel 14 thereby eliminating the need for the track rail 82 and contact brushes. In addition, a more positive engagement between the drive surface 75 and the drive wheel 64 may be used. For example, an intermeshing gear may be provided on the drive wheel 64 and the drive surface 75 may be provided with a corresponding ring gear.

FIG. 14 is a front view of an illuminated advertising trash receptacle 100 in accordance with another embodiment of the present invention. In the illustrated embodiment, the illuminated advertising trash receptacle 100 has a rectangular shape and includes a plurality of side walls, only one side wall 102 being shown, that define an interior space for receiving refuse or other objects therein via opening 103. In addition, the illuminated advertising trash receptacle 100 includes a base 104 that houses various components as described below that enhances advertisement effectiveness by allowing viewing of more than one advertisement.

In this embodiment, at least one of the side walls, in the illustrated embodiment, the side wall 102, has an illuminated display screen 106 attached thereto. The display screen 106 is adapted to display plurality of electronic advertisements and to change the displayed advertisement periodically to thereby allow viewing of more than one advertisement. The display screen 106 may be implemented as an LCD, LED, plasma screens, or any other appropriate illuminated screens for displaying electronic advertisements and may even be an array of LED lights for displaying a moving message. Of course, additional illuminated display screens may be provided on one or more of the other side walls of the illuminated advertising trash receptacle 100.

In the illustrated embodiment, the display screen 106 is a touch sensitive screen of the type known in the art that allows the viewer of the advertisement to interact with displayed electronic advertisement. For example, the displayed advertisement may request the viewer of the advertisement to touch a portion of the display screen 106 to display additional information regarding the advertised product and/or service.

The base 104 of the illuminated advertising trash receptacle 100 houses various components for allowing the display of electronic advertisements on the display screen 106. In this regard, FIG. 15 shows a schematic view of the base 104 including a power source, such as a plurality of batteries 110, that provides the electrical power required by the illuminated display screen 106 to display electronic advertisements thereon. As noted above with respect to the prior embodiment of the present invention, the batteries 110 may be automotive or marine type batteries although in other embodiments, different power sources such as different types of batteries and even fuel cells may be used instead.

The base 104 of the illustrated embodiment also includes a storage device 112 adapted to store the plurality of electronic advertisements which can be displayed on the display screen 106 periodically. In this regard, the storage device 112 may be implemented as an optical, magnetic, or flash storage media. Of course, other types of storage technology may be used to implement the storage device 112 in other embodiments as well. A controller 114 is also provided in the base 104 of the illuminated advertising trash receptacle 100 which is electrically connected to the display screen 106 and the storage device 112. In accordance with the present embodiment, the controller 114 is adapted to control which of the plurality of electronic advertisements stored in the stored in the storage device 112 is displayed on the display screen 106. Of course, in another embodiment, the controller 114 and the storage device 112 may be implemented as a computer, such as a handheld computer, having a CPU and a hard drive that allows storage and control of the plurality of electronic advertisements.

The duration of displaying a particular electronic advertisement on the display screen 106 may be based on any appropriate parameter including advertisement fee paid, time of day, etc. The frequency of changing the electronic advertisement displayed on the display screen 106 is preferably based at least on the duration of time each of the electronic advertisements are displayed on the display screen 106.

In addition, the illuminated advertising trash receptacle 100 is further provided with additional features that enhance the effectiveness of the advertisement displayed. In particular, in the illustrated embodiment of FIG. 14, the illuminated advertising trash receptacle 100 is provided with speakers 120 that broadcast audio information to viewers of the electronic advertisements regarding the product and/or service being electronically advertised, and to draw interest of other potential viewers to the illuminated advertising trash receptacle 100. The audio information may be stored in the storage device 112 in electronic format which is associated with the corresponding electronic advertisement also stored in the storage device 112.

Furthermore, the illuminated advertising trash receptacle 100 of the present embodiment is provided with a sensor 122 that is adapted to detect presence of an individual viewing the electronic advertisements displayed. In this regard, the sensor 122 may be implemented as an infrared sensor which is powered by the power source of the illuminated advertising trash receptacle 100. In such an embodiment, the controller 114 further includes a counter, i.e. a counter circuit or program, for counting number of individuals that view the electronic advertisements displayed on the display screen 106 as detected by the sensor 122. This information can be stored in the storage device 112 in electronic format and later retrieved for evaluation and analysis as to the effectiveness of the illuminated advertising trash receptacle 100 and/or the electronic advertisement displayed.

Moreover, the illuminated embodiment of the advertising trash receptacle 100 is provided with a receiver/transmitter 122 electrically connected to the controller 114, the receiver/transmitter 122 being adapted to receive transmissions of the electronic advertisements for storage into the storage device 112, and to transmit information regarding the status of the illuminated advertising trash receptacle 100 and/or electronic advertisements being displayed. This is an especially advantageous feature that allows new electronic advertisements to be easily uploaded into the storage device 112 using a corresponding transmitter device (not shown). In addition, the transmitter feature further allows easy monitoring of the condition and function of the illuminated advertising trash receptacle 100 using a corresponding receiver (not shown). The receiver/transmitter 122 may be implemented using any appropriate technology including infrared based technology or radio frequency based technology such as Bluetooth. Of course, other technologies may be used in implementing the receiver/transmitter 122 in other embodiments as well, and a hard wire connection may alternatively be used to upload electronic advertisements into the storage device 112.

In accordance with still another aspect of the present invention, a method of advertising is provided, the method including the steps of providing at least one advertisement trash receptacle at a property location, the advertisement trash receptacle having an interior space to receive trash therein, advertising products and/or services of a sponsor in the advertisement trash receptacle, collecting a fee from the sponsor for the advertisement in the advertisement trash receptacle, and paying at least a portion of the collected fee from the sponsor to owner of the property location. In accordance with another embodiment, the present method may further include the steps of regularly servicing the advertisement trash receptacle, where the servicing is performed without cost to the owner of the property location.

By utilizing such a method of advertising, the owner of the property location can be encouraged to use the illuminated advertising waste receptacle of the present invention thereby ensuring proliferation of such devices. In this regard, the ubiquitous nature of waste receptacles allows the real estate occupied by the illuminated advertising waste receptacles of the present invention to be used to establish a low power local wireless network as described below within buildings or other structures such as malls, airports, etc. where reception of wireless service may be degraded.

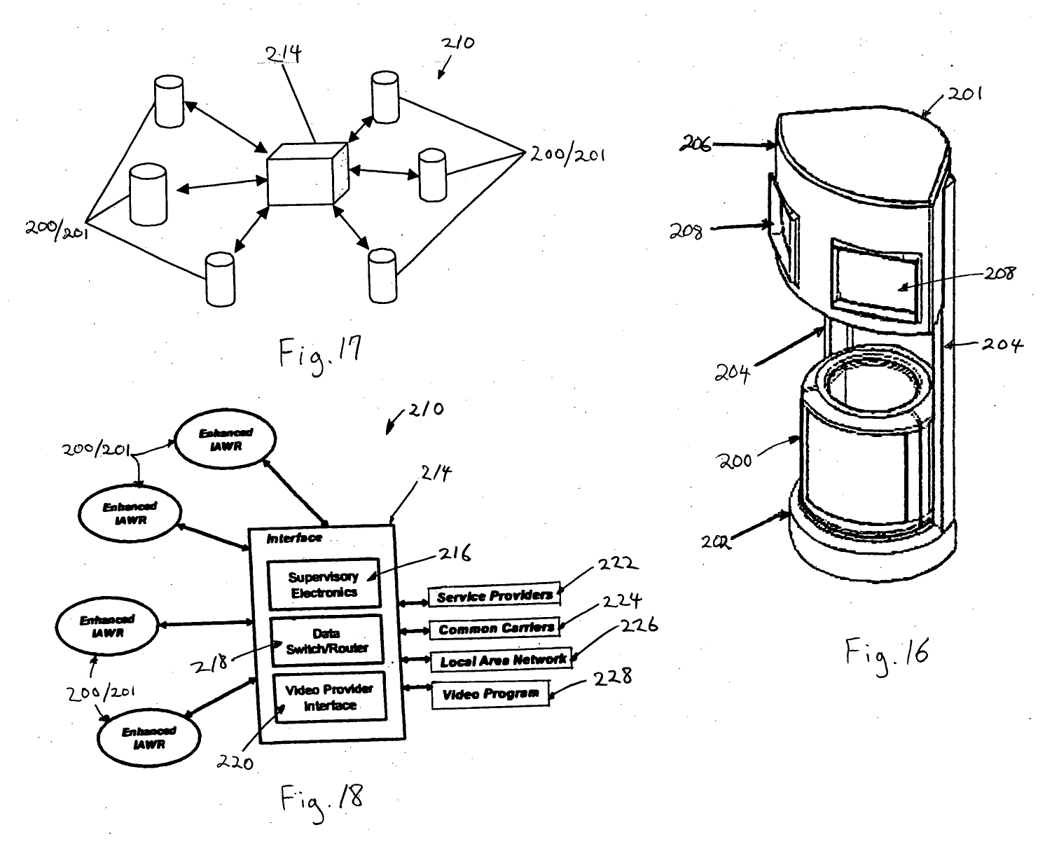

FIG. 16 illustrates one embodiment of an illuminated advertising trash receptacle 200 implemented with a tower docking station 201 in accordance with another embodiment of the present invention. In the illustrated embodiment, the trash receptacle 200 may be of the type shown in FIG. 1 or FIG. 14. The tower docking station 201 is provided with a base 202 for removably receiving the waste receptacle 10 therein, and support columns 204 that support a components bay 206 that houses an antenna, transmitter and receiver, as well as other electronic components necessary to serve as an access point for the local wireless network. In addition, the components bay 206 of the tower docking station 201 in the illustrated embodiment is also provided with a plurality of screens 208 for displaying various information including instructions for accessing the services that may be available through the local wireless network. Of course, in other embodiments, alternative implementations may be provided. For example, the tower docking station 201 may be integrated with the illuminated advertising trash receptacle 200 so that they are one single unit. In addition, the components bay 206 need not be provided with the plurality of screens 208 shown or provide any information to the users.

Preferably, the tower docking station 201 is sized so that it does not take much more ground space than already required by the illuminated advertising waste receptacle 200. In addition, because of the increase power requirements, the tower docking station 201 is preferably provided with continual power source such as by accessing the electrical utility grid rather than by portable power sources discussed above. In this implementation, the power source for the illuminated advertising waste receptacle 200 would also preferably be the electrical utility grid rather than by portable power sources discussed since such power source is readily available.

FIG. 17 illustrates a schematic diagram showing how a local wireless network 210 may be established. As shown, the wireless network 210 includes a plurality of illuminated advertising waste receptacles 200 with tower docking stations 201. Thus, each of the plurality of illuminated advertising waste receptacles with tower docking stations 201 serve as places for disposing refuse and a transmitter receiver station that allows access to the local wireless network 210. The plurality of tower docking stations 201 of the present embodiment are electrically connected to a central interface 214, the details of which are more clearly illustrated in FIG. 18.

As shown in FIG. 18, the central interface 214 includes various components for implementing the local wireless network 210, and connects the local wireless network 210 to the main wireless network that provides wireless service to users. In the illustrated embodiment, the central interface 214 is provided with supervisory electronics 216, a data switch/router 218, and a video provider interface 220. The supervisory electronics 229 manages the various components of, and/or data transmitted and processed through, the central interface 214. In this regard, the central interface 214 is further connected to service providers 222, common carriers 224, and local area network 226 to thereby expand and integrate the local wireless network 210 to the main wireless network.

Moreover, the illustrated embodiment of the central interface 214 is connected to video program 228 which provides video data that can be processed by the video provider interface 220. In this regard, the video data may be the electronic advertisement that is to be displayed by the illuminated advertising trash receptacle 200 and/or the screens 208 of the tower docking stations 201.

By establishing a low powered local wireless network 210 using plurality of illuminated advertising trash receptacles 200 with associated tower docking stations 201, wireless services can be provided in buildings or other structures such as malls, airports, etc. where reception of wireless service may be degraded. As a user moves through the building or structure in which the local wireless network 210 is established, the user's signal may be handed off from one components bay 206 at one location to another. Because the ubiquitous nature of trash receptacles in such structures such as malls and airports, illuminated advertising trash receptacle 200 with tower docking stations 201 as described above can be readily provided in strategic locations so that the user's access to the local wireless network 210 is ensured.

Of course, it should be noted that any variety of wireless technologies may be used to implement the low powered local wireless network 210 as described. Such wireless technologies include cellular, Personal Communications System (PCS), wireless local area networks (WLAN), 3G, and other wireless technologies.

Moreover, in accordance with yet another aspect of the present invention, a fee may be associated with the use of the local wireless network 210 established. This access fee may be paid by the wireless service provider and thus, transparent to the user. The access fee may further be incurred only when the user is, or is about to be dropped by, the primary network of the wireless service provider. In such an instance, the user's wireless access can be handed off to the local wireless network 210. Such access fees would be negotiated before allowing access to the local wireless network 210. In addition, such fees may be used to further reduce the cost of advertising using the illuminated advertising trash receptacles 10 to thereby further encourage the adoption and proliferation of such illuminated advertising trash receptacles.

While various embodiments in accordance with the present invention have been shown and described, it is understood that the invention is not limited thereto. The present invention may be changed, modified and further applied by those skilled in the art. Whereas certain features have been described as applied to certain embodiments, it should be noted that such features may be readily applied to other embodiments. For example, the use of portable, rechargeable power source and/or use of a sequencer feature for sequentially starting lighting devices disclosed may also be applied to the embodiments of FIGS. 1, 14 and 16, as well as others. The feature of providing a speaker for audio information and/or a sensor to detect presence of viewers may also be applied to these and other embodiments as well. Therefore, this invention is not limited to the detail shown and described previously with respect to the embodiments described, but also includes all such changes and modifications.

We claim:

1. An illuminated advertising trash receptacle that allows viewing of more than one advertisement comprising:
a stationary base;
a power source;
an illuminated carousel having at least one substantially transparent viewing area sized to housing advertisements therein, and an interior space sized to receive a liner container therein;
at least one lighting device to evenly illuminate said advertisements, said lighting device having dimensions substantially same as said viewing area;
a turntable positioned to support said illuminated carousel on said stationary base, said turntable being adapted to allow rotation of said illuminated carousel relative to said stationary base; and
a drive mechanism for rotating said illuminated carousel relative to said stationary base.

2. The illuminated advertising trash receptacle of claim 1, wherein said turntable supports said illuminated carousel includes a friction reducing bearing that facilitates rotation of said carousel by said drive mechanism.

3. The illuminated advertising trash receptacle of claim 1, wherein said drive mechanism includes an electric motor.

4. The illuminated advertising trash receptacle of claim 3, wherein said electric motor is mounted to rotate with said illuminated carousel.

5. The illuminated advertising trash receptacle of claim 3, wherein said turntable includes a track rail that provides power from said power source to said electric motor as said carousel rotates relative to said stationary base.

6. The illuminated advertising trash receptacle of claim 3, further comprising a load circuit that monitors load on said electric motor.

7. The illuminated advertising trash receptacle of claim 6, wherein said load circuit terminates power to said electric motor when said monitored load exceeds a predetermined load.

8. The illuminated advertising trash receptacle of claim 1, wherein said at least one lighting device is a plurality of lighting devices.

9. The illuminated advertising trash receptacle of claim 8, further comprising a sequencer that provides power from said power source to each of said plurality of lighting devices sequentially so that one lighting device is turned on at a time.

10. The illuminated advertising trash receptacle of claim 9, wherein said sequencer is further adapted to supply power to said drive mechanism after sequentially providing power to each of said plurality of lighting devices.

11. The illuminated advertising trash receptacle of claim 1, wherein said power source is a portable, rechargeable power source.

12. The illuminated advertising trash receptacle of claim 11, wherein said power source is a plurality of rechargeable batteries.

13. The illuminated advertising trash receptacle of claim 11, wherein said power source is a fuel cell.

14. The illuminated advertising trash receptacle of claim 13, wherein said fuel cell includes a fuel container including at least one of nickel metal hydride and borax therein.

15. The illuminated advertising trash receptacle of claim 1, wherein said at least one lighting device includes a light guide.

16. The illuminated advertising trash receptacle of claim 15, wherein said light guide is made from an acrylic sheet.

17. The illuminated advertising trash receptacle of claim 1, wherein said at least one lighting device is an electroluminescent lamp.

18. The illuminated advertising trash receptacle of claim 1, further including a components bay that houses an antenna, transmitter and receiver to allow said illuminated advertising trash receptacle to function as an access point for a local wireless network.

19. An illuminated advertising trash receptacle that allows viewing of more than one advertisement comprising:
at least one side wall;
a power source;
a storage device adapted to store a plurality of electronic advertisements;
a display screen attached to an outer surface of said at least one side wall, said display device being adapted to display at least one of said plurality of electronic advertisements; and
a controller adapted to change which of said plurality of electronic advertisements is displayed on said display screen.

20. The illuminated advertising trash receptacle of claim 19, wherein said controller changes which electronic advertisement is displayed on said display screen based at least on duration of time each of said electronic advertisements are displayed.

21. The illuminated advertising trash receptacle of claim 19, wherein said display screen is at least one of an LCD, LED and plasma screen.

22. The illuminated advertising trash receptacle of claim 21, wherein said display screen is touch sensitive to allow viewer interaction with displayed electronic advertisement.

23. The illuminated advertising trash receptacle of claim 19, further comprising a receiver adapted to receive transmissions of said electronic advertisements.

24. The illuminated advertising trash receptacle of claim 19, further comprising a transmitter to transmit information status of said illuminated advertising trash receptacle and electronic advertisements being displayed.

25. The illuminated advertising trash receptacle of claim 19, further comprising a speaker to provide audio information to viewers of said electronic advertisements.

26. The illuminated advertising trash receptacle of claim 19, further comprising a sensor adapted to detect presence of an individual viewing said plurality of electronic advertisements displayed, and a counter for counting number of individuals that viewed said plurality of electronic advertisements displayed.

27. The illuminated advertising trash receptacle of claim 19, further including a components bay that houses an antenna, transmitter and receiver to allow said illuminated advertising trash receptacle to function as an access point for a local wireless network.

28. A method of advertising comprising the steps of:
providing at least one advertisement trash receptacle at a property location, said at least one advertisement trash receptacle having an interior space to receive trash therein;
advertising products and/or services of a sponsor in said at least one advertisement trash receptacle;
collecting a fee from said sponsor for said advertisement in said at least one advertisement trash receptacle; and
paying at least a portion of said collected fee from said sponsor to owner of said property location.

29. The method of claim 28, further including the step of regularly servicing said at least one advertisement trash receptacle.

30. The method of claim 29, wherein said step of servicing said at least one advertisement trash receptacle is performed without cost to said owner of said property location.

31. The method of claim 30, further including the step of providing a plurality of advertisement trash receptacles, said plurality of advertisement trash receptacles including a components bay housing an antenna, transmitter and receiver which allow said plurality of advertisement trash receptacles to serve as access points for a local wireless network.

32. The method of claim 31, further including the step of charging a fee for accessing said local wireless network.

33. An illuminated advertising trash receptacle that allows viewing of a plurality of advertisements comprising:
a stationary base;
a power source;
a plurality of viewing areas that allow viewing of said plurality of advertisements;
a plurality of lighting devices to evenly illuminate said advertisements, said lighting devices being dimensioned to correspond to said viewing area; and
a sequencer that provides power from said power source to each of said plurality of lighting devices sequentially so that one lighting device is turned on at a time.

34. An illuminated advertising trash receptacle that allows viewing of at least one advertisement comprising:
a stationary base;
at least one viewing area that allows viewing of said advertisement;
at least one lighting device to evenly illuminate said advertisement, said lighting device having dimensions substantially same as said viewing area; and
a portable, rechargeable power source for providing power to said at least one lighting device.

35. The illuminated advertising trash receptacle of claim 34, wherein said power source is a fuel cell.

36. The illuminated advertising trash receptacle of claim 35, wherein said fuel cell includes a fuel container including at least one of nickel metal hydride and borax therein.

37. An illuminated advertising trash receptacle that allows viewing of at least one advertisement comprising:
a stationary base;
a power source;
at least one viewing area that allows viewing of said advertisement;
at least one lighting device to evenly illuminate said advertisement, said lighting device having dimensions substantially same as said viewing area; and
a components bay that houses an antenna, transmitter and receiver to allow said illuminated advertising trash receptacle to function as an access point for a local wireless network.

38. An illuminated advertising trash receptacle that allows viewing of at least one advertisement comprising:
a stationary base;
a power source;
at least one viewing area that allows viewing of said advertisement;
at least one lighting device to evenly illuminate said advertisement, said lighting device having dimensions substantially same as said viewing area; and
a speaker to provide audio information to viewers of said advertisement.

39. An illuminated advertising trash receptacle that allows viewing of at least one advertisement comprising:
a stationary base;
a power source;
at least one viewing area that allows viewing of said advertisement;
at least one lighting device to evenly illuminate said advertisement, said lighting device having dimensions substantially same as said viewing area; and
a sensor adapted to detect presence of an individual viewing said advertisement.

40. The illuminated advertising trash receptacle of claim 39, further comprising a counter for counting number of individuals that viewed said advertisement.
